(19) United States
(12) Patent Application Publication
(10) Pub. No.: US 2005/0129408 A1
(43) Pub. Date: Jun. 16, 2005

(54) Optical transmission system for removing skew between optical channels

(76) Inventors: Byoung Sung Kim, Daejeon-city (KR); Je Soo Ko, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/930,081

(22) Filed: Aug. 30, 2004

(30) Foreign Application Priority Data
Dec. 15, 2003 (KR) 2003-91334

(51) Int. Cl. H04B 10/00

(52) U.S. Cl. 398/140

(57) ABSTRACT

An optical transmission system for removing skew between optical channels is provided. The optical transmission system comprises an optical signal transmitter and an optical signal receiver. The optical transmitter inserts serial numbers into an overhead of a frame, delays the frame by a time corresponding to skew information transmitted from an opposite optical transmission system, and transmits the frame. The optical signal receiver receives the frame from the opposite optical transmission system via fiber optics, removes skew existing in the received frame in units of both a byte and a frame by referring to the serial numbers stored in the overhead of the frame, and transmits the skew information collected when the skew is removed, to the opposite optical transmission system.

### BACKGROUND OF THE INVENTION

This application claims the priority of Korean Patent Application No. 2003-91334, filed on Dec. 15, 2003, in the Korean Intellectual Property Office, the disclosure of which is incorporated herein in its entirety by reference.

1. Field of the Invention

The present invention relates to an optical communication system, and more particularly, to an apparatus for removing skew between channels occurring in an optical communication system.

2. Description of the Related Art

Problems such as a rise in price due to a high-priced transmitting/receiving module, reduction in an optical transmission distance due to the nonlinearity of fiber optics, and current technical restriction occur when transmitting an optical signal having a high speed of several tens of Gbps. Such problems can be solved by demultiplexing a signal having a high speed of several tens of Gbps into a low-speed multi-channel signal and then by optically transmitting the low-speed signal.

FIG. 1 is a block diagram of conventional N-channel (M/N) Gbps optical transmission systems 100 and 200 which perform M Gbps signal transmission with an overhead. Referring to FIG. 1, the optical transmission systems 100 and 200 include optical signal transmitters 110 and 210 and optical signal receivers 160 and 260, respectively.

The optical signal transmitters 110 and 210 include demultiplexers 130 and 230 and N (M/N) Gbps E/O converters 151-15n and 251-25n, respectively. The optical signal transmitters 110 and 210 demultiplex an M Gbps signal with an overhead into N (M/N) Gbps optical signals and perform medium and long distance transmission to the opposite optical transmission systems 200 and 100 at intervals of several tens of kms via fiber optics. The optical signal receivers 160 and 260 include N (M/N) Gbps O/E converters 171-17n and 271-27n and multiplexers 190 and 290, respectively, and multiplex N (M/N) Gbps optical signals transmitted from the opposite optical transmission systems 200 and 100 into original M Gbps signals.

Compared to current high-speed transmission technology, a low-speed optical transmitting/receiving module is low-priced, long distance transmission using fiber optics can be executed, and the development of technology and the manufacture and supply of a product have stabilized. Thus, the optical signal transmitters 110 and 210 demultiplex a high-speed signal into a low-speed multi-channel signal and optically transmit the signal, and the optical signal receivers 160 and 260 multiplex the signal received from the optical signal transmitters 160 and 260 and restore the signal to an original signal, causing technical and economical advantages.

However, it is very difficult to make the transmission distance between N channels equal, and due to the time delay of a circuit constituting optical signal transmitters and receivers, the actual transmission distance may vary for each channel. Thus, even though the optical signal transmitters 110 and 210 have transmitted N signals having a frame structure at the same position and at the same time, the optical signal receivers 160 and 260 receive N signals at different points of time. Thus, in order to multiplex N signals received by the optical signal receivers 160 and 260 into original M Gbps signals, it is very important to trace the position of a frame between the N received signals and to remove a difference in time between frames, that is, skew.

### SUMMARY OF THE INVENTION

The present invention provides an optical transmission system for removing skew between channels that may occur when in an optical communication system for demultiplexing a signal with an overhead into an N-channel signal, optically transmitting and receiving the signal and multiplexing the signal into an original signal.

According to an aspect of the present invention, there is provided an optical transmission system for removing skew between optical channels. The optical transmission system includes an optical signal transmitter inserting serial numbers into an overhead of a frame, delaying the frame by a time corresponding to skew information transmitted from an opposite optical transmission system, and transmitting the frame; and an optical signal receiver receiving the frame from an opposite optical transmission system via fiber optics, removing skew existing in the received frame in units of both a byte and a frame by referring to the serial numbers stored in the overhead of the frame, and transmitting the skew information collected when the skew is removed, to the opposite optical transmission system.

According to another aspect of the present invention, there is provided an optical transmission system for removing skew between optical channels. The optical transmission system includes a serial number inserter inserting serial numbers into an overhead of a frame; a demultiplexer demultiplexing the frame into which the serial numbers are inserted, into N electrical signals; an aligner delaying the N electrical signals for a predetermined amount of time in response to skew information transmitted from an opposite optical transmission system; N E/O converters converting the N electrical signals output from the aligner into N optical signals, so as to transmit the N electrical signals to an opposite optical transmission system; N O/E converters converting the N optical signals received from the opposite optical transmission system via fiber optics, into N electrical signals; a skew remover removing skew existing in the N electrical signals in units of both a byte and a frame by referring to the serial numbers stored in the overhead of the N electrical signals and transmitting the skew information collected when the skew is removed, to the opposite optical transmission system; and a multiplexer multiplexing a signal output from the skew remover into an original signal.

### BRIEF DESCRIPTION OF THE DRAWINGS

The above aspects and advantages of the present invention will become more apparent by describing in detail exemplary embodiments thereof with reference to the attached drawings in which:

FIG. 1 is a block diagram of conventional N-channel (M/N) Gbps optical transmission systems which perform M Gbps signal transmission with an overhead;

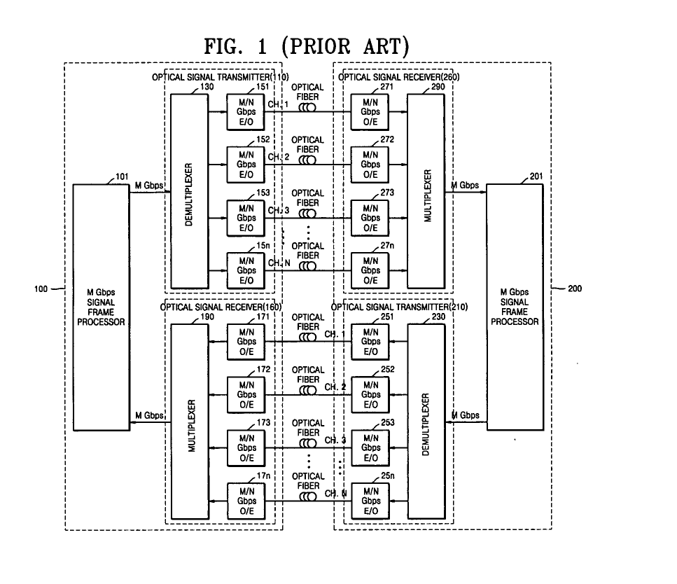

FIG. 2 is a block diagram showing the structure of N-channel (M/N) Gbps optical transmission systems which include an apparatus for removing skew between optical channels according to an embodiment of the present invention and perform M Gbps signal transmission;

FIG. 3 is a block diagram showing the structure of 4-channel 10 Gbps optical transmission systems (M=40, N=4) which include an apparatus for removing skew between optical channels according to an embodiment of the present invention and perform 40 Gbps STM-256 signal transmission;

FIG. 4 shows the structure of a 40 Gbps STM-256 signal frame according to an embodiment of the present invention;

FIG. 5 shows the structure of a signal frame in which the 40 Gbps STM-256 signal frame shown in FIG. 4 is deinterleaved into four channels;

FIG. 6 is a block diagram showing the structure of an aligner of the optical signal transmitter shown in FIG. 3;

FIG. 7 is a block diagram showing the structure of a skew remover of the optical signal receiver shown in FIG. 3;

FIG. 8 is a block diagram showing the structure of a byte unit skew remover shown in FIG. 7;

FIG. 9 shows an input/output signal of the byte unit skew remover shown in FIG. 8;

FIG. 10 is a block diagram showing the structure of a frame unit skew remover shown in FIG. 7;

FIG. 11 shows an input/output signal of the frame unit skew remover shown in FIG. 10; and

FIG. 12 shows an operation of a total skew quantity calculator shown in FIG. 7.

### DETAILED DESCRIPTION OF THE INVENTION

Hereinafter, exemplary embodiments of the present invention will be described in detail with reference to the accompanying drawings.

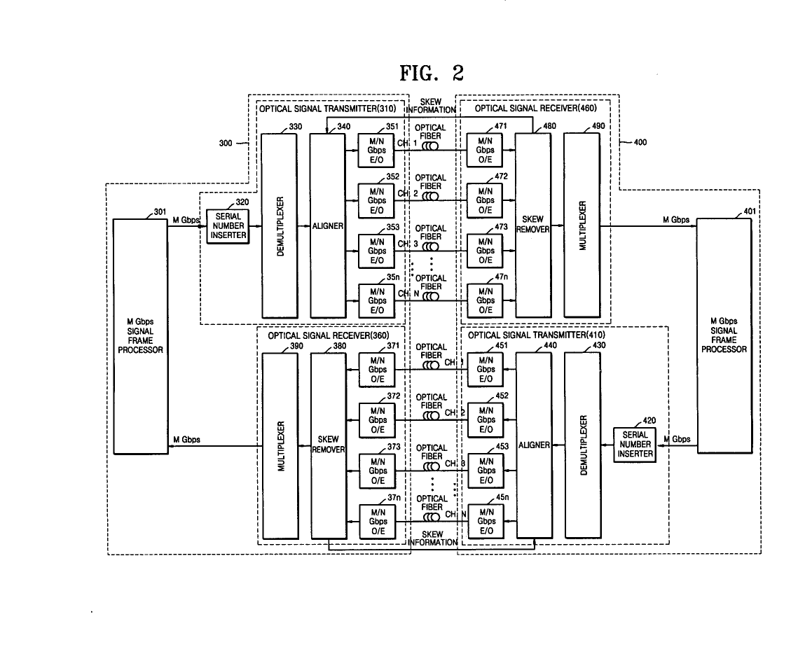

FIG. 2 is a block diagram showing the structure of N-channel (M/N) Gbps optical transmission systems 300 and 400 which include an apparatus for removing skew between optical channels according to an embodiment of the present invention and perform M Gbps signal transmission. Referring to FIG. 2, the optical transmission systems 300 and 400 include optical signal transmitters 310 and 410 and optical signal receivers 360 and 460, respectively.

The optical signal transmitters 310 and 410 include serial number inserters 320 and 420, demultiplexers 330 and 430, aligners 340 and 440, and N (M/N) Gbps E/O converters 351-35n and 451-45n, respectively. The serial number inserters 320 and 420 insert serial numbers into part of an overhead of an M Gbps frame in the order of frames. The serial numbers serve as a kind of recognition mark when removing skew in the optical signal receivers 360 and 460.

The demultiplexers 330 and 430 demultiplex an M Gbps frame, into which the serial numbers are inserted, into N (M/N) Gbps electrical signals. The aligners 340 and 440 receive skew information from skew removers 480 and 380 of the opposite optical transmission systems 400 and 300 and delay an electrical signal frame generated by the demultiplexers 330 and 430 for a predetermined amount of time. In this case, the skew information includes byte information of a signal frame received by the opposite optical transmission systems 400 and 300 and delay information of a frame. The N (M/N) Gbps E/O converters 351-35n and 451-45n convert the electrical signal output from the aligners 340 and 440 into N (M/N) Gbps optical signals. The optical signals converted by the E/O converters 351-35n and 451-45n are transmitted to the opposite optical transmission systems 400 and 300 via fiber optics.

The optical signal receivers 360 and 460 include N (M/N) Gbps O/E converters 371-37n and 471-47n, skew removers 380 and 480, and multiplexers 390 and 490.

The N (M/N) Gbps O/E converters 371-37n and 471-47n convert N (M/N) Gbps optical signals transmitted from the opposite optical transmission systems 400 and 300 to N (M/N) Gbps electrical signals. The skew removers 380 and 480 perform a skew-removing operation in each byte and a skew-removing operation in each frame on each of the N (M/N) Gbps electrical signals generated by the (M/N) Gbps O/E converters 371-37n and 471-47n. The multiplexers 390 and 490 multiplex signals output from the skew removers 380 and 480 into the original M Gbps signal.

FIG. 2 shows data flow in transmission and reception directions of the two optical transmission systems 300 and 400. The skew-removing operations are the same in the transmission and reception directions, and a skew-removing operation in each of the transmission and reception directions is performed independently.

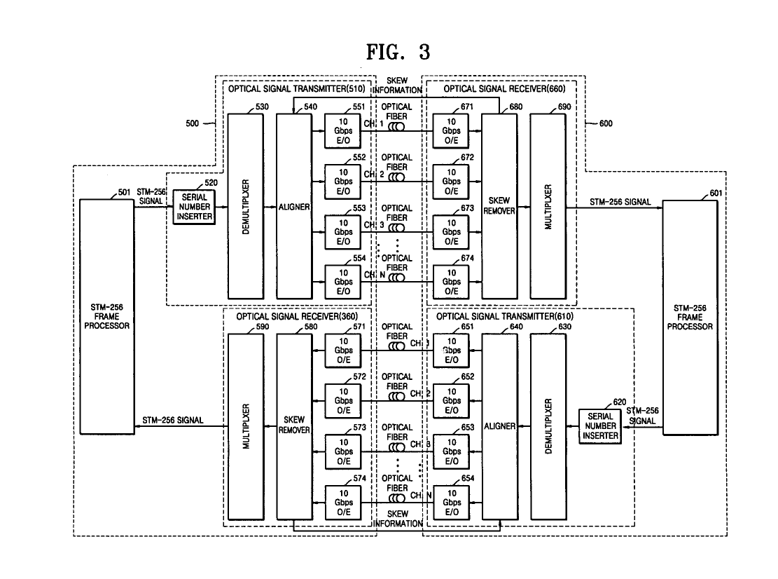

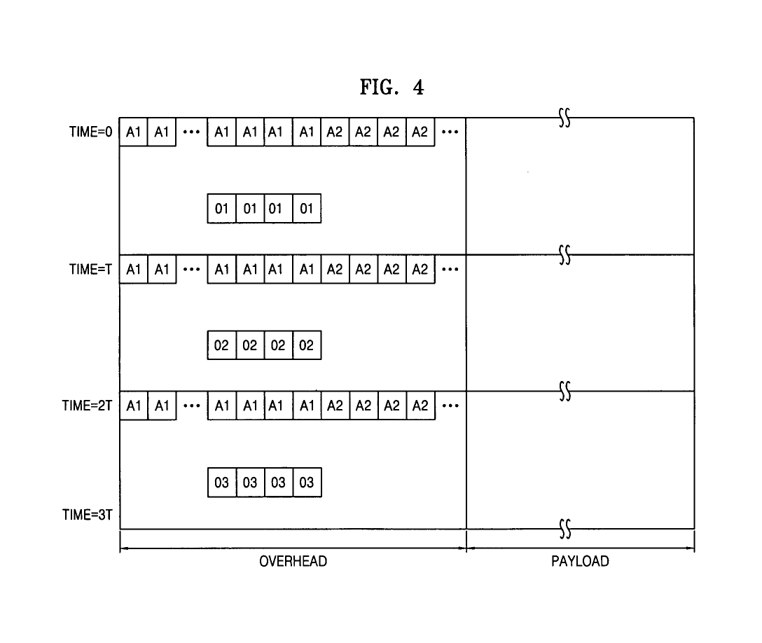

FIG. 3 is a block diagram showing the structure of 4-channel 10 Gbps optical transmission systems 500 and 600 (M=40, N=4) which include an apparatus for removing skew between optical channels according to an embodiment of the present invention and perform 40 Gbps STM-256 signal transmission, and FIG. 4 shows the structure of a 40 Gbps STM-256 signal frame according to an embodiment of the present invention.

The basic configuration of the four-channel 10 Gbps optical transmission systems 500 and 600 shown in FIG. 3 is the same as that of the N-channel (M/N) Gbps optical transmission systems 300 and 400 shown in FIG. 2, except that the number of processed channels is different from each other. Thus, repeated descriptions will be omitted.

FIG. 3 shows data flow in transmission and reception directions of the two optical transmission systems 500 and 600. The skew-removing operations are the same in the transmission and reception directions, and a skew-removing operation in each of the transmission and reception directions is performed independently. Thus, for explanatory convenience, the optical transmission system 500 which performs optical transmission of a 40 Gbps STM-256 signal using four channels (M=40 and N=4) will now be described. First, the structure and operation of an optical signal transmitter 510 of the optical transmission system 500 will be described with reference to FIG. 3.

A serial number inserter 520 inserts serial numbers into part of an overhead of a STM-256 frame in the order of frames.

Referring to FIG. 4, the STM-256 frame is divided into an overhead and a payload, and reserved bytes are contained in the overhead. The serial number inserter 520 inserts serial numbers (for example, 01, 02, and 03) into the reserved 4 bytes arranged in series in an overhead of a frame in the order of the frames, because the STM-256 signal is demultiplexed into four signals.

For example, if the STM-256 signal is demultiplexed into N STM-K signals (where N×K=256), N bytes in total are needed. Inserting serial numbers in each byte intends to deinterleave the STM-256 signal in each byte when the STM-256 signal is demultiplexed into the four-channel STM-64 signal. If a demultiplexing technique is used, serial numbers corresponding thereto are inserted.

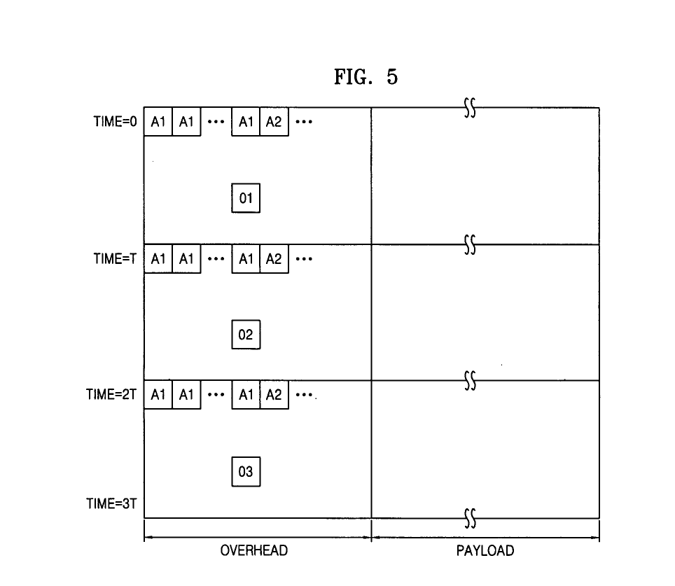

FIG. 5 shows the structure of a signal frame in which the 40 Gbps STM-256 signal frame shown in FIG. 4 is deinterleaved into four channels. FIG. 5 shows only one signal frame, but the other three signal frames have the same frame structure.

Referring to FIGS. 3 and 5, the serial number inserter 520 sets an initial number and a maximum number when inserting serial numbers and starts from the initial number and stops when the serial number reaches the maximum number. The serial numbers and a boundary between A1 and A2 bytes serves as kinds of recognition marks when removing skew in an optical signal receiver 660. In a synchronous digital hierarchy (SDH) frame structure, the A1 byte generally has a value of F6 (hexa), and the A2 byte has a value of 28 (hexa).

When inserting the serial numbers is performed, a demultiplexer 530 demultiplexes a 40 Gbps frame, into which the serial numbers are inserted, into four 10 Gbps electrical signals and outputs the demultiplexed electrical signals to an aligner 540.

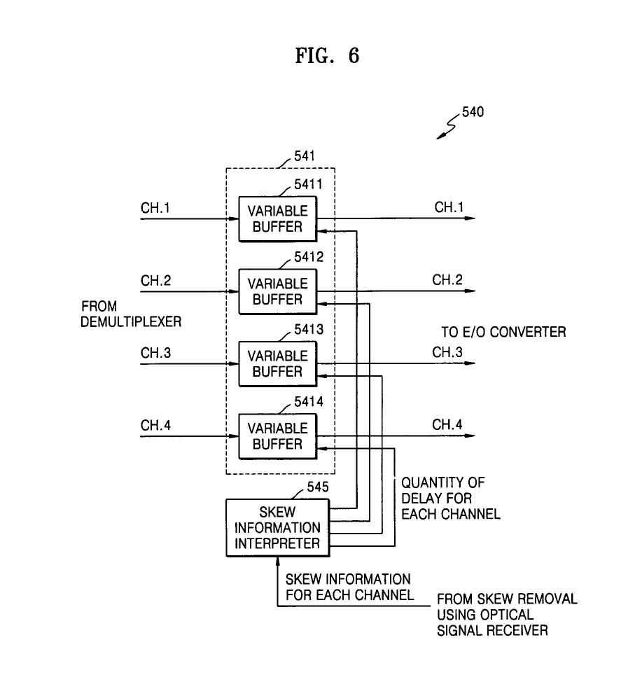

FIG. 6 is a block diagram showing the structure of the aligner 540 of the optical signal transmitter 510 shown in FIG. 3. Referring to FIGS. 3 and 6, the aligner 540 includes a buffer unit 541 comprising four variable buffers 5411, 5412, 5413, and 5414, and a skew information interpreter 545.

The skew information interpreter 545 interprets the quantity of delay at each channel in response to skew information for each channel transmitted from a skew remover 680 of the opposite optical transmission system 600 and transmits the interpreted delay-quantity information for each channel into the variable buffers 5411, 5412, 5413, and 5414 allocated to each channel. In this case, the skew information supplied from the skew remover 680 includes byte delay information of a signal frame for each of four channels received from the optical signal receiver 660 of the opposite optical transmission system 600 and delay information of the frame. Each of the variable buffers 5411, 5412, 5413, and 5414 delays an electrical signal frame of a corresponding channel by the quantity of delay for each channel transmitted from the skew information interpreter 545 and outputs the delayed signal frame to each of E/O converters 551, 552, 553, and 554. The E/O converters 551, 552, 553, and 554 convert the electrical signals output from the aligner 540 into four 10 Gbps optical signals. The optical signal converted by the E/O converters 551, 552, 553, and 554 is transmitted to the optical transmission system 600 via fiber optics.

The structure and operation of the optical signal receiver 660 of the optical transmission system 500 will now be described below.

When the four 10 Gbps optical signals are received from the opposite optical transmission systems 400 and 300, four O/E converters 571, 572, 573, and 574 convert the received optical signals into 10 Gbps electrical signals, and a skew remover 580 removes skew in each of the four 10 Gbps electrical signals generated in the O/E converters 571, 572, 573, and 574.

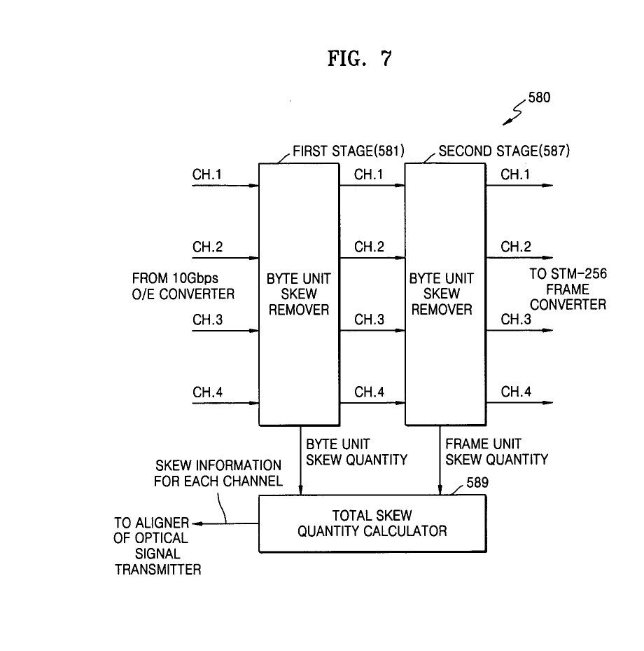

FIG. 7 is a block diagram showing the structure of the skew remover 580 of the optical signal receiver 560 shown in FIG. 3. Referring to FIG. 7, the skew remover 580 includes a byte unit skew remover 581, a frame unit skew remover 587, and the total skew quantity calculator 589.

The byte unit skew remover 581 removes skew in units of a byte due to a difference in lengths of optical transmission paths to this end, the byte unit skew remover 581 makes a boundary between A1 and A2 bytes contained in the four frames received from the O/E converters 571, 572, 573, and 574 be the same, thereby removing skew in each frame.

The frame unit skew remover 587 removes skew in units of a frame that may occur during the transmission/reception of an optical signal. A time delay that may occur during the transmission/reception of an optical signal may exceed the period of one frame. In a synchronous digital hierarchy (SDH) frame structure, the period of one frame is 125 ms. Skew caused by the time delay in units of a frame is removed using serial numbers inserted into the frame.

The total skew quantity calculator 589 calculates the total skew quantity by receiving the skew quantity in units of a byte and the skew quantity in units of a frame for each channel from the byte unit skew remover 581 and the frame unit skew remover 587, respectively, and transmits skew information for each channel to an aligner 640 of the opposite optical signal transmission system 600 which transmits current data. In this case, the skew information for each channel is transmitted to the aligner 640 by using a control line path separated from four optical channels or by transmitting information calculated in an overhead of the signal frame to be transmitted via an optical channel and analyzing the information using the opposite optical signal transmission system 600. In this way, the optical signal transmission system according to the present invention removes skew in received signals using a skew remover in units of a byte and in units of a frame and feeds back skew information analyzed during skew removal to an aligner of an opposite optical signal transmission system. The opposite optical signal transmission system delays a frame to be transmitted by a predetermined amount of time based on input skew information so that skew does not occur during signal transmission. As a result, skew that occurs during transmission/reception of an optical signal can be effectively removed.

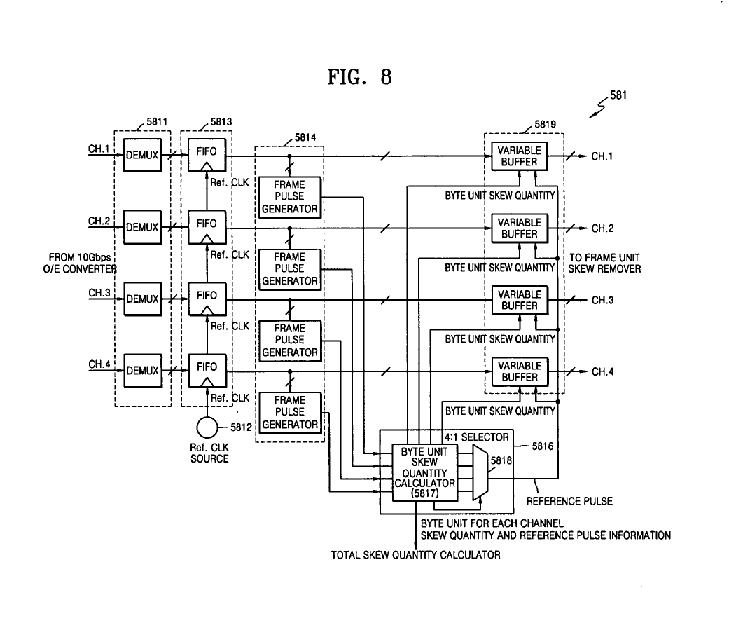

FIG. 8 is a block diagram showing the structure of the byte unit skew remover 581 shown in FIG. 7. Referring to FIG. 8, the byte unit skew remover 581 includes four demultiplexers 5811 connected to each channel, four FIFOs 5813, four frame pulse generators 5814, four variable buffers 5819, a byte unit skew quantity calculating unit 5816 commonly connected between the four frame pulse generators 5814 and the four variable buffers 5819, and a reference clock source 5812 connected to the four FIFOs 5813. The byte unit skew quantity calculating unit 5816 includes a byte unit skew quantity calculator 5817 and a 4:1 selector 5818.

The four-channel signal received from the O/E converters 571, 572, 573, and 574 is demultiplexed using the demultiplxer 5811 for each channel, is converted into a parallel signal, and is input into the FIFOs 5813, so as to perform processing on an electronic circuit. Each parallel signal stored in the FIFOs 5813 is synchronized with a reference clock signal generated in the reference clock source 5812 and is output to the frame pulse generators 5814 and the variable buffers 5819 for each channel.

The frame pulse generators 5814 find a boundary between A1 and A2 bytes by analyzing the structure of a frame for each channel and generates a pulse signal according to the period of the frame. In this case, it is assumed that there is no skew between parallel signals of one channel because the parallel signals are separated in parallel on the same electronic circuit and transmitted and this assumption is reasonable.

The pulse signal generated in each of the frame pulse generators 5814 is input into the byte unit skew quantity calculator 5817 of the byte unit skew quantity calculating unit 5816, and the quantity of skew between channels is calculated in units of a byte. In this case, a relative skew quantity is calculated in units of a byte based on a pulse signal that reaches the byte unit skew quantity calculator 5817 the latest during a period corresponding to one frame. In other words, the pulse signal that reaches the byte unit skew quantity calculator 5817 the latest, is selected as a reference pulse using the 4:1 selector 5818 and is transmitted to each of the variable buffers 5819, and the variable buffers 5819 output the signal based on the reference pulse. In this case, the byte unit skew quantity calculator 5817 transmits the quantity of skew calculated in units of a byte for each channel to each of the variable buffers 5819, each of which correspond to one channel. The variable buffers 5819 adjust the size of a buffer so that the position of each frame output from the variable buffers 5819 is the same.

In a procedure of removing skew in units of a byte, skew between four channels in units of a byte is removed, and the position of the frame is made the same, but skew in units of a frame is not removed. Removing skew in units of a frame is performed using the frame unit skew remover 587 connected to an output terminal of the byte unit skew remover 581.

The quantity of skew calculated in units of a byte for each channel using the byte unit skew quantity calculator 5817 is transmitted to the total skew quantity calculator 589 of the skew remover 580. In this case, information on a channel that reaches the byte unit skew quantity calculator 5817 the latest during the period corresponding to one frame is together transmitted to the total skew quantity calculator 589.

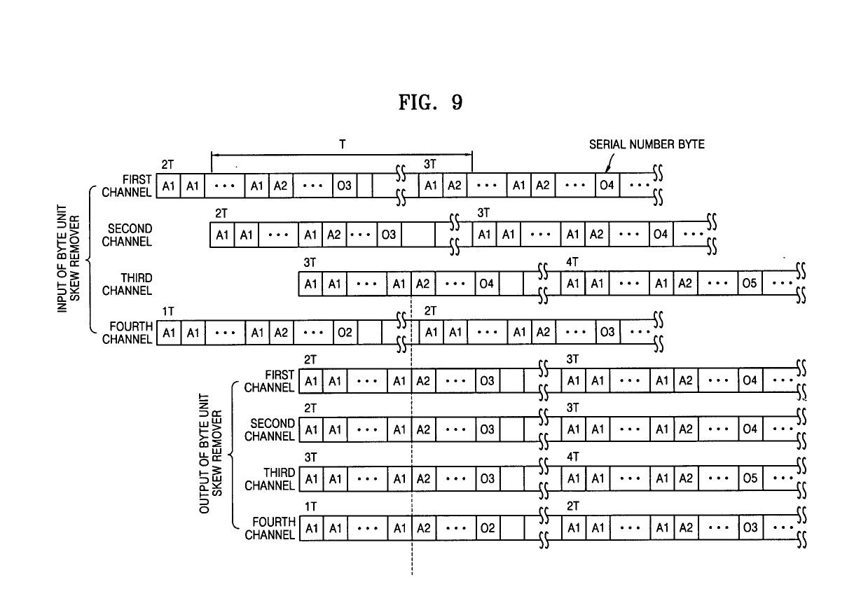

FIG. 9 shows an input/output signal of the byte unit skew remover 581 shown in FIG. 8. Referring to FIGS. 8 and 9, with respect to data input for each channel during time T of one frame, a boundary between A1 and A2 bytes of three channels reaches the byte unit skew remover 581 the latest. In this case, the byte unit skew remover 581 makes the A1 and A2 bytes of each channel be the same by delaying a frame of different channels (that is, a first channel, a second channel, and a fourth channel) based on the information on the boundary between the A1 and A2 bytes of the three channels that reaches the byte unit skew remover 581 the latest. An output of the byte unit skew remover 581 is input into the frame unit skew remover 587.

The byte unit skew remover 581 can make the position of bytes in the frame equal by introducing a delay in units of a byte in each frame of each channel using information on the boundary between the A1 and A2 bytes of the overhead of the frame. However, when a difference in time between a frame reaching the byte unit skew remover 581 the earliest and a frame reaching the byte unit skew remover 581 the latest is greater than a half-period of the frame, a delay in units of a frame occurs. Thus, it is difficult to restore the position of a frame for each channel during signal transmission of the optical signal transmitter using only the byte unit skew remover 581. Thus, a skew removing operation is performed in units of both a byte and a frame so that skew can be more effectively removed.

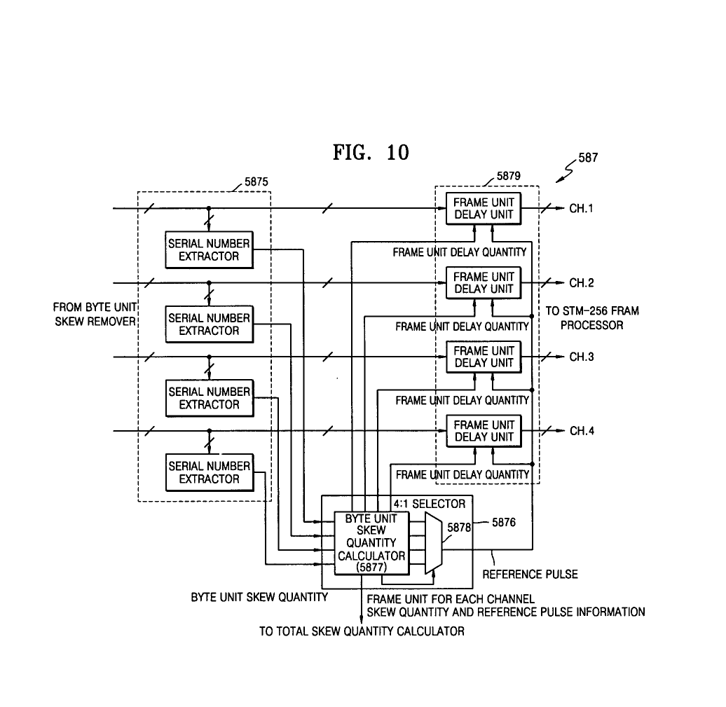

FIG. 10 is a block diagram showing the structure of the frame unit skew remover 587 shown in FIG. 7.

Referring to FIGS. 7 and 10, the frame unit skew remover 587 includes four serial number extractors 5875 connected for each channel, four frame unit delay units 5879, and a frame unit skew quantity calculating unit 5876 commonly connected between the four serial number extractors 5875 and the four frame unit delay units 5879. The frame unit skew quantity calculating unit 5876 includes a frame unit skew quantity calculator 5877 and a 4:1 selector 5878.

The four-channel signal received from the byte unit skew remover 581 is input into the serial number extractor 5875 and the frame unit delay unit 5879. The serial number extractor 5875 extracts serial numbers by retrieving the overhead of the received signal. The serial numbers extracted by each of the serial number extractors 5875 for each of the four channels are input into the frame unit skew quantity calculator 5877, and the quantity of skew is calculated in units of a frame for each of the four channels. The calculated skew quantity is input into each of the frame unit delay units 5879, and a frame signal of each channel is delayed in units of a frame. Each of the frame unit delay units 5879 uses a reference pulse signal output from the frame unit skew quantity calculator 5877 as a reference signal. The frame unit skew quantity calculator 5877 outputs a frame pulse signal that reaches the frame unit skew quantity calculator 5877 the latest during a period of one frame, as the reference pulse signal. A calculation result (that is, a skew quantity in units of a frame) of the skew quantity of each channel using the frame unit skew quantity calculator 5877 is transmitted to the total skew quantity calculator 589 of the skew remover 580. In this case, information on a channel that reaches the frame unit skew quantity calculator 5877 the latest during a period corresponding to one frame, is together transmitted to the total skew quantity calculator 589.

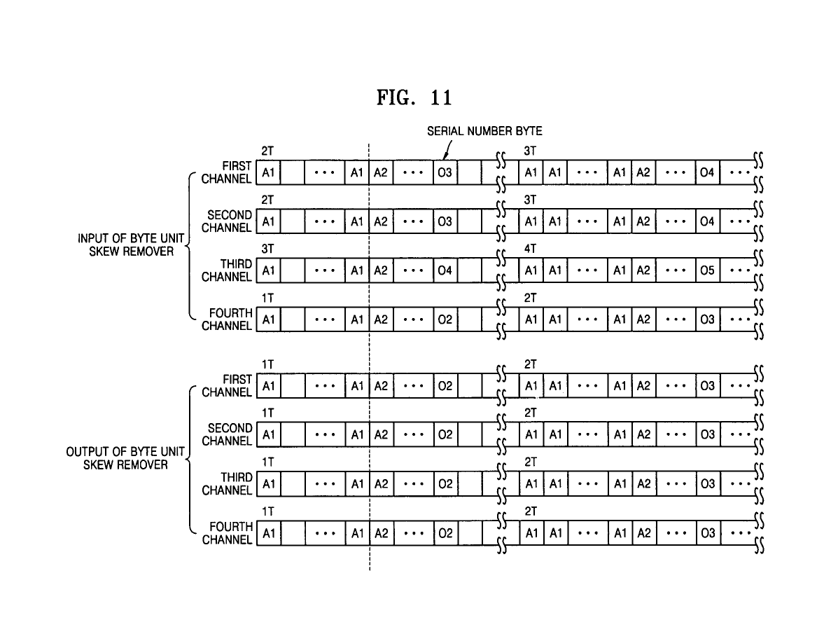

FIG. 11 shows an input/output signal of the frame unit skew remover 587 shown in FIG. 10.

Referring to FIGS. 9 through 11, an output of the byte unit skew remover 581 shown in FIG. 7 is used as an input of the frame unit skew remover 587. A serial number byte indicates that information on a fourth channel reaches the frame unit skew quantity calculator 5877 by a time corresponding to a period of one frame later than first and second channels and by a time corresponding to a period of two fames later than a third channel. In this case, the frame unit delay unit 5879 shown in FIG. 10 delays the first and second channels by one frame and delays the third channel by two frames so that the position of frames of the first through third channels is the same as the position of frames of the fourth channel.

In this way, the skew remover 580 performs an operation of removing a byte/frame skew between input channels using a combined operation of the byte unit skew remover 581 and the frame unit skew remover 587. Each of the skew quantity and reference pulse information for each channel output from the skew quantity calculator 5817 of the byte unit skew remover 581 and the skew quantity calculator 5877 of the frame unit skew remover 587 is input into the total skew quantity calculator 589. The total skew quantity calculator 589 calculate a skew quantity for each channel by analyzing the input information and feeds back the calculated skew information to an aligner of an opposite optical signal transmitter. In this way, the skew is removed and simultaneously, is corrected so that the skew that varies in a real-time can be more easily removed.

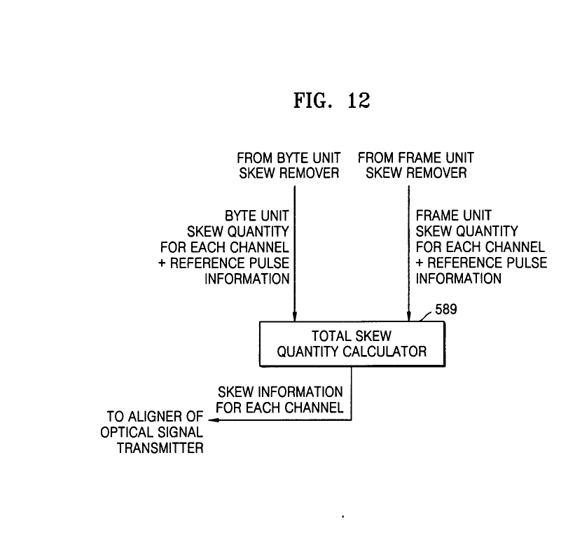

FIG. 12 shows an operation of the total skew quantity calculator 589 shown in FIG. 7.

Referring to FIG. 12, the total skew quantity calculator 589 calculates a skew quantity for each channel by performing the following operation. If a third channel of the byte unit skew remover 581 generates a reference pulse signal, there are skew quantities such as delta_{—}1_byte, delta_{—}2_byte, and delta_{—}4_byte in the first, second, and fourth channels based on the third channel. And, if the fourth channel of the frame unit skew remover 587 generates the reference pulse signal, there are skew quantities such as delta_{—}1_frame, delta_{—}2_frame, and delta_{—}3_frame in the first, second, and third channels based on the fourth channel. As a result, (delta_{—}1_byte+delta_{—}1_frame) is loaded on the first channel of the skew information, (delta_{—}2_byte+delta_{—}2_frame) is loaded on the second channel thereof, (0+delta_{—}3_frame) is loaded on the third channel thereof, and (delta_{—}4_{—}+0) is loaded on the fourth channel thereof.

The total skew quantity calculator 589 calculates a total skew quantity in this manner and feeds back the calculated skew information to the aligner 640 of the opposite optical signal transmitter 600. The aligner 640 of the opposite optical signal transmitter 600 interprets the skew information using the skew information interpreter 545 and adjusts the buffering quantity of each of the variable buffers of the aligner 640 using the interpreted skew information so that a final skew quantity of an optical signal receiver is 0.

When the buffering quantity of each variable buffer is adjusted, due to rapid adjustment of a skew quantity, the aligner 640 prevents a frame from disappearing at one channel of four channels during a period of one frame, because the skew information interpreter of the aligner 640 adjusts the buffering quantity of each variable buffer gradually by a small quantity according to time. An increase in the skew quantity according to time can be prevented by gradually adjusting the skew quantity using the aligner 640.

An apparatus for removing skew between optical channels or an optical transmission system for removing skew between the optical channels according to the present invention are implemented with a single chip shape or a field programmable gate array (FPGA) and can be applied to actual applications. In the present invention, a byte similar to a sequential indicator H4 byte of a payload overhead (POH) used in virtual connection is used. However, this is only a part of the invention, and the present invention is not limited to the structure of a frame suggested in an ITU-T G.707 standard document and instead can be applied to a frame with an overhead, such as STM-256, STM-4, STM-16, and STM-64.

As described above, in the optical transmission system for removing skew between the optical channels according to the present invention, skew occurring in a received signal is removed in units of both a byte and a frame, and skew information analyzed during skew removal is fed back to an opposite optical signal transmitter, and a frame to be transmitted is delayed for a predetermined amount of time so that skew does not occur during signal transmission. As such, skew, which is a delay or time difference between optical channels that may occur due to a difference in lengths of optical transmission paths and time delay caused by an electronic circuit composing a transceiver, can be effectively removed.

While the present invention has been particularly shown and described with reference to exemplary embodiments thereof, it will be understood by those skilled in the art that various changes in form and details may be made therein without departing from the spirit and scope of the invention as defined by the following claims.

1. An optical transmission system comprising:
an optical signal transmitter inserting serial numbers into an overhead of a frame, delaying the frame by a time corresponding to skew information transmitted from an opposite optical transmission system, and transmitting the frame; and
an optical signal receiver receiving the frame from an opposite optical transmission system via fiber optics, removing skew existing in the received frame in units of both a byte and a frame by referring to the serial numbers stored in the overhead of the frame, and transmitting the skew information collected when the skew is removed, to the opposite optical transmission system.

2. The optical transmission system of claim 1, wherein the optical signal transmitter comprises:
a serial number inserter inserting the serial numbers into the overhead of the frame to be transmitted to the opposite optical transmission system;
a demultiplexer demultiplexing the frame into which the serial numbers are inserted, into N electrical signals;
an aligner delaying the N electrical signals for a predetermined amount of time in response to the skew information transmitted from the opposite optical transmission system; and
N E/O converters converting the N electrical signals output from the aligner into N optical signals.

3. The optical transmission system of claim 1, wherein the optical signal receiver comprises:
N O/E converters converting N optical signals received from the opposite optical transmission system into N electrical signals;
a skew remover removing skew existing in the N electrical signals in units of both a byte and a frame by referring to the serial numbers stored in the overhead of the N electrical signals and transmitting the skew information collected when the skew is removed, to the opposite optical transmission system; and
a multiplexer multiplexing a signal output from the skew remover into an original signal.

4. The optical transmission system of claim 2, wherein the aligner comprises:
N variable buffers storing each of the N electrical signals output from the demultiplexer for each channel; and
a skew information interpreter receiving the skew information from the opposite optical transmission system, interpreting the quantity of delay to be delayed for each channel, and transmitting the interpreted quantity of delay to the N variable buffers,
wherein the N variable buffers delay a frame of the N electrical signals of a corresponding channel by the quantity of delay transmitted from the skew information interpreter.

5. The optical transmission system of claim 3, wherein the skew remover comprises:
a byte unit skew remover removing skew existing in each frame in units of a byte by making a boundary between A1 and A2 bytes contained in the frame of the N electrical signals be the same;
a frame unit skew remover removing the skew in units of a frame by referring to the serial numbers inserted into the frame output from the byte unit skew remover; and
a total skew quantity calculator receiving each of a skew quantity and reference pulse information in units of a byte and a frame from the byte unit skew remover and the frame unit skew remover, calculating a total quantity of skew, and transmitting skew information for each channel to the opposite optical signal transmitter.

6. The optical transmission system of claim 5, wherein the byte unit skew remover comprises:
N demultiplexers demultiplexing the N electrical signals received from the O/E converters for each channel;
N FIFOs receiving the demultiplexed N electrical signals for each channel, being synchronized with a reference clock signal, and outputting the signals for each channel;
N frame pulse generators finding the boundary between the A1 and A2 bytes by analyzing the structure of a frame of the signals output from the N FIFOs and generating a pulse signal according to a period of the boundary;
a byte unit skew quantity calculating unit setting a pulse signal that reaches the byte unit skew quantity calculating unit the latest during a period corresponding to one frame as a reference pulse and calculating a quantity of skew existing between channels of the pulse signal generated by the frame pulse generator in units of a byte; and
N variable buffers outputting the signals transmitted from the N FIFOs by adjusting the size of a buffer to correspond to the quantity of skew in units of a byte for each channel in response to the reference pulse generated by the byte unit skew quantity calculating unit.

7. The optical transmission system of claim 5, wherein the frame unit skew remover comprises:
N serial number extractors extracting serial numbers by retrieving the overhead of the frame received for each channel from the byte unit skew remover;
a frame unit skew quantity calculating unit setting a pulse signal that reaches the byte unit skew quantity calculating unit the latest during a period corresponding to one frame as a reference pulse and calculating a quantity of skew existing in each channel from the serial numbers extracted by the serial number extractor in units of a frame; and
N frame unit delay units delaying the signals of the frame of each channel to correspond to the quantity of skew in units of a frame for each channel in response to the reference pulse generated by the frame unit skew quantity calculating unit.

8. An optical transmission system comprising:
a serial number inserter inserting serial numbers into an overhead of a frame;
a demultiplexer demultiplexing the frame into which the serial numbers are inserted, into N electrical signals;
an aligner delaying the N electrical signals for a predetermined amount of time in response to skew information transmitted from an opposite optical transmission system;
N E/O converters converting the N electrical signals output from the aligner into N optical signals, so as to transmit the N electrical signals to an opposite optical transmission system;
N O/E converters converting the N optical signals received from the opposite optical transmission system via fiber optics, into N electrical signals;
a skew remover removing skew existing in the N electrical signals in units of both a byte and a frame by referring to the serial numbers stored in the overhead of the N electrical signals and transmitting the skew information collected when the skew is removed, to the opposite optical transmission system; and
a multiplexer multiplexing a signal output from the skew remover into an original signal.

9. The optical transmission system of claim 8, wherein the aligner comprises:
N variable buffers storing each of the N electrical signals output from the demultiplexer for each channel; and
a skew information interpreter receiving the skew information from the opposite optical transmission system, interpreting the quantity of delay to be delayed for each channel, and transmitting the interpreted quantity of delay to the N variable buffers,
wherein the N variable buffers delay a frame of the N electrical signals of a corresponding channel by the quantity of delay transmitted from the skew information interpreter.

10. The optical transmission system of claim 8, wherein the skew remover comprises:
a byte unit skew remover removing skew existing in each frame in units of a byte by making a boundary between A1 and A2 bytes contained in the frame of the N electrical signals be the same;
a frame unit skew remover removing the skew in units of a frame by referring to the serial numbers inserted into the frame output from the byte unit skew remover; and
a total skew quantity calculator receiving each of a skew quantity and reference pulse information in units of a byte and a frame from the byte unit skew remover and the frame unit skew remover, calculating a total quantity of skew, and transmitting skew information for each channel to the opposite optical signal transmitter.
